(19) United States
(12) Patent Application Publication
(10) Pub. No.: US 2025/0302036 A1
(43) Pub. Date: Oct. 2, 2025

(54) PHTHALIMIDE FUNGICIDE COMPOSITION

(71) Applicant: Adama Makhteshim Ltd., Beer Sheva (IL)

(72) Inventors: Diana Poliak, Beer Sheva (IL); Anna Praiz, Beer Sheva (IL); Viacheslav Firer Slava, Beer Sheva (IL); Ivan Gorlovetsky, Beer Sheva (IL)

(73) Assignee: Adama Makhteshim Ltd., Beer Sheva (IL)

(21) Appl. No.: 18/864,362

(22) PCT Filed: May 11, 2023
(86) PCT No.: PCT/IB2023/054887

§ 371 Date: Nov. 8, 2024

Related U.S. Application Data
(60) Provisional application No. 63/340,807, filed on May 11, 2022.

(51) Int. Cl. A01N 25/22; A01N 25/04; A01N 47/04; A01P 3/00

(52) U.S. Cl. CPC A01N 25/22; A01N 25/04; A01N 47/04; A01P 3/00

(57) ABSTRACT

This invention relates to a composition comprising phthalimide fungicide and acetic acid-based buffer. The invention further relates to a process for preparing the composition according to the invention and to the use of said composition. The invention additionally relates to a method of treating a plant, or a part of a plant, against a pathogen, comprising contacting the plant, or part of the plant, with said composition.

Throughout this application various publications are referenced. The disclosures of these documents in their entireties are hereby incorporated by reference into this application in order to more fully describe the state of the art to which this invention pertains.

### FIELD

The present invention relates to composition comprising a phthalimide fungicide and acetic acid-based buffer. The invention further relates to methods for producing the composition and to methods of preventing, reducing and/or eliminating the presence of a phytopathogen on a plant or on one or more plant parts, comprising applying a composition of the invention to said plant or plant part.

### INTRODUCTION

Agricultural pest control includes chemical control is based on substances that are toxic to the pests involved, while causing little or no toxic effects to the agricultural plants.

Chemical control agents can be incredibly beneficial and have contributed to increased food production over the past century. Many compositions in agriculture are based on water as carrier.

Phthalimide fungicides are non-systemic contact fungicides which are used for controlling a variety of pathogens in different crops. Different compositions are known comprising phthalimide fungicides especially, folpet (N-(trichloromethylthio)phthalimide) and/or captan (N-(trichloromethylthio)cyclohex-4-ene-1,2-dicarboximide). Most phthalimides such as folpet and captan are hardly soluble in water. Examples of current commercial formulations are Phoenix, Folpan 80WDG, Merpan 80WDG with high concentrations of folpet and captan as active ingredient in the range of 30-70%. Liquid compositions of phthalimide, such as Merpan 47.5 SC, are also known.

It is an objective of the present invention to improve the stability of compositions comprising phthalimide fungicide during storage.

### SUMMARY OF THE INVENTION

The present invention provides a composition comprising phthalimide fungicide and acetic acid-based buffer.

The present invention provides an aqueous based composition comprising a phthalimide fungicide and acetic acid-based buffer.

The present invention provides a composition comprising (1) an amount of phthalimide fungicide (2) an amount of acetic acid-based buffer and (3) water, wherein the phthalimide is suspended in the water.

The present invention provides an aqueous based composition comprising (1) phthalimide fungicide, (2) polyelectrolyte complex and (3) acetic acid-based buffer.

The present invention provides a process for producing composition comprising phthalimide fungicide and acetic acid-based buffer.

The present invention provides a method of protecting a plant, or a part of a plant, against a pathogen, comprising treating said plant, or part of said plant, with a composition according to the invention.

The present invention provides a method of preventing, reducing and/or eliminating the presence of a pathogen on a plant, or a part of a plant, comprising treating said plant, or part of said plant, with a composition according to the invention.

The present invention provides a method of controlling diseases caused by phytopathogenic fungi in plants or on propagation material thereof which comprises treating the plants, or propagation material thereof, with a composition according to the invention.

### DETAILED DESCRIPTION

### Definitions

Unless defined otherwise, all technical and scientific terms used herein have the meaning commonly understood by persons of ordinary skill in the art to which this subject matter pertains.

The term “a” or “an”, as used herein, includes the singular and the plural, unless specifically stated otherwise. Therefore, the terms “a,” “an,” or “at least one” can be used interchangeably in this application.

As used herein, the term “about” when used in connection with a numerical value includes +10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention. For example, “30-45%” includes 30%, 30.1%, 30.2%, etc. up to 45%.

The term “polyelectrolyte”, as is used herein, refers to a molecule consisting of a plurality of functional, charged groups that are linked to a polymer backbone. In the context of this application, the term “polycation” is interchangeable with the term “positively charged polyelectrolyte”, while the term “polyanion” is interchangeable with the term “negatively charged polyelectrolyte”. The terms polycation and polyanion refer to positively charged and negatively charged polymer molecules, respectively, under neutral or acidic conditions, i.e. at pH 3-8. Moreover, the term “polycation” refer to a cationic polymer and the term “polyanion” refer to a anionic polymer.

The term “polyelectrolyte complex”, as is used herein, refers to a structure that is formed by interaction of at least one polycation with at least one polyanion. Polyelectrolyte complexes are described, for example, in WO 2013/133705 and WO 2013/133706, the contents of each of which are hereby incorporated by reference. An example of polyelectrolyte complex may be a “polyelectrolyte matrix” (“PEM”).

The term “polyelectrolyte matrix”, as is used herein, refers to a network that is formed by interaction of at least one polycation with at least one polyanion that result in a matrix-like physical structure.

The term “lignin compound”, as is used herein, refers to a chemical compound that is derived from naturally occurring lignin or lignen by a process that includes sulphonation. The resulting sulfonic acids are strong acids and lignin compounds are therefore negatively charged at pH values below 7.

As used herein, the term “chitosan” refers to a linear polysaccharide composed of randomly distributed β-(1-4)-linked D-glucosamine (deacetylated unit) and N-acetyl-D-glucosamine (acetylated unit). Chitosan is produced by deacetylation of chitin. The term “chitosan” includes chitosan, chitosan derivatives and mixtures of chitosan and chitosan derivatives.

The term “crop”, as is used herein, include cereals such as wheat, barley, rye, oats, sorghum and millet, rice, cassava and maize, and crops that produce, for example, peanut, sugar beet, cotton, soya, oilseed rape, potato, tomato, peach and vegetables.

The term “part of a plant”, as is used herein, indicates a part of a plant including, but not limited to, pollen, ovule, leaf, root, flower, fruit, stem, bulb, corn, branch and seed.

The term “bioactive ingredient”, as is used herein with connection to an additional bioactive ingredient, refers to a chemical substance capable of controlling pests and/or killing living organisms. Bioactive ingredients are commonly used in medicine, agriculture, forestry, and in industry where they prevent the fouling of, for example, water, agricultural products including seed, and oil pipelines. A bioactive ingredient can be a pesticide, including a fungicide, herbicide, insecticide, algicide, molluscicide, miticide and rodenticide; and/or an antimicrobial such as a germicide, antibiotic, antibacterial, antiviral, antifungal, antiprotozoal and/or antiparasitic compound.

As used herein, the term “pest” includes, but is not limited to, insect, nematode, weed, fungi, algae, mite, tick, and animal. Said pest preferably is a phytopathogenic fungi, an unwanted insect, and/or a weed.

As is used herein, the term “pesticide” includes, but is not limited to, a herbicide, insecticide, fungicide, nematocide, mollusks repellent and a control agent.

The terms “controlling a pest” and “pest control”, as used herein, refers to preventive, persistence, curative and/or knock down treatment of a pest.

The term “concentrated and/or ready mix”, as used herein, refers to a composition intended for dilution with water prior to use.

The term “suspension concentrate”, as used herein, refers to a suspension of solid particles in a liquid intended for dilution with water prior to use. In some embodiments, suspension concentrate refers to an aqueous suspension concentrate.

The term “tank mix”, as used herein, refers to at least two compositions that are mixed in the spray tank prior to the application or at the time of spray application.

As used herein, the term “w/w” means percentage by weight based on the total weight of the composition or combination.

### Composition of Phthalimide Fungicide

Formulating a stable composition comprising phthalimide fungicide, especially in high concentration of at least 30% by weight, is a challenge.

Phthalimide fungicides when formulated especially in presence of water requires a buffer for maintaining the pH above 4. However, it was found very challenging to maintain the pH above 4 for a long period and surprisingly, it was found that acetic acid-based buffer, maintains the pH of the composition above 4 during storage.

Stable compositions comprising phthalimide fungicide, as well as their methods of use and processes of preparation, are described below.

It was found that the presence of acetic acid-based buffer in the composition which comprises phthalimide fungicide, maintains the pH above 4 after storage.

The present invention provides a composition comprising phthalimide fungicide and acetic acid-based buffer.

In some embodiments, the present invention provides an aqueous based composition comprising a phthalimide fungicide and acetic acid-based buffer.

In some embodiments, the present invention provides a composition comprising (1) an amount of phthalimide fungicide (2) an amount of acetic acid-based buffer and (3) water, wherein the phthalimide is suspended in the water.

In some embodiments, the composition is a concentrated composition.

In some embodiments, the composition is a liquid composition.

In some embodiments, the composition is a suspension concentrate.

In some embodiments, the aqueous concentrate is a suspoemulsion composition.

In some embodiments, the composition is a solid composition.

In some embodiments, the solid composition is a powder.

In some embodiments, the solid composition is a granule.

In some embodiments, the solid composition is a water dispersible granules (WDG).

In some embodiments, the composition further comprises polyelectrolyte complex.

In some embodiments, the present invention provides an aqueous based composition comprising (1) phthalimide fungicide, (2) polyelectrolyte complex and (3) acetic acid-based buffer.

In some embodiments, the phthalimide fungicide is folpet, captan and/or captafol.

In some embodiments, the phthalimide fungicide is folpet.

In some embodiments, the phthalimide fungicide is captan.

In some embodiments, the phthalimide fungicide is captafol.

In some embodiments, the concentration of the phthalimide fungicide is between 0.1% to 99% by weight based on the total weight of the composition.

In some embodiments, the concentration of the phthalimide fungicide is between 5% to 90% by weight based on the total weight of the composition.

In some embodiments, the concentration of the phthalimide fungicide is between 10% to 85% by weight based on the total weight of the composition.

In some embodiments, the concentration of the phthalimide fungicide is up to 80% by weight based on the total weight of the composition.

In some embodiments, the concentration of the phthalimide fungicide is up to 70% by weight based on the total weight of the composition.

In some embodiments, the concentration of the phthalimide fungicide is at least 35% by weight based on the total weight of the composition.

In some embodiments, the concentration of the phthalimide fungicide is about 50% by weight based on the total weight of the composition.

In some embodiments, the concentration of the phthalimide fungicide in the composition according to the invention is between 10 and 800 g/L. In some embodiments, the concentration of the phthalimide fungicide in the composition is between 100 and 500 g/L. In some embodiments, the concentration of the phthalimide fungicide in the composition is between 300 and 400 g/L. In some embodiments, the concentration of the phthalimide fungicide in the composition is between 350 and 600 g/L. In some embodiments, the concentration of the phthalimide fungicide in the composition is about 512 g/L.

In some embodiments, the concentration of the phthalimide fungicide in a composition according to the invention is 10-80% by weight based on the total weight of the composition. In some embodiments, the concentration of the phthalimide fungicide in the composition is 10-50% by weight based on the total weight of the composition. In some embodiments, the concentration of the phthalimide fungicide in the composition is 25-40% by weight based on the total weight of the stable composition.

In some embodiments, the concentration of the phthalimide fungicide in the composition is up to 45% by weight based on the total weight of the composition.

In some embodiments, the concentration of the phthalimide fungicide in the composition is 30-40% by weight based on the total weight of the composition.

In some embodiments, the concentration of the phthalimide fungicide in the composition is 43% by weight based on the total weight of the composition.

In some embodiments, the composition comprises 30-80% by weight of water. In some embodiments, the composition comprises 30-60% by weight of water. In some embodiments, the composition comprises 30-45% by weight of water. In some embodiments, the composition comprises about 37% by weight of water.

In some embodiments, the composition comprises an amount of the acetic acid-based buffer that provides a pH level of 4 to 7 before storage.

In some embodiments, the composition is stable. In some embodiments, the composition is physically stable. In some embodiments, the composition is stable after storage, including storage for the durations described above at temperatures described below.

In some embodiments, the composition is stored for a period between 2 weeks and 24 months prior to application. In some embodiments, the composition is stored for 2 months prior to application. In some embodiments, the composition is stored for 3 months prior to application. In some embodiments, the composition is stored for 6 months prior to application. In some embodiments, the composition is stored for 2 weeks at 54° C.

In some embodiments, stable, as used herein in connection with physical stability, refers to maintain pH above 4.

In some embodiments, the concentration of the acetic acid in the composition is up to 5% by weight based on the total weight of the composition.

In some embodiments, the concentration of the acetic acid in the buffer is up to 25% by weight based on the total weight of the buffer.

In some embodiments, the concentration of the conjugate base in the composition is up to 5% by weight based on the total weight of the composition.

In some embodiments, the concentration of the conjugate base in the buffer is up to 85% by weight based on the total weight of the buffer.

In some embodiments, the conjugate base is agriculturally acceptable acetate salt.

In some embodiments the weight ratio between the phthalimide fungicide and the acetic acid-based buffer is between 200:1 to 6:1. In some embodiments, the weight ratio between the phthalimide fungicide and the acetic acid-based buffer is 30:1 to 10:1.

In some embodiments, the composition further comprises at least one additional bioactive.

In some embodiments, the composition further comprises a surfactant.

In some embodiments, the surfactant is a non-ionic surfactant.

In some embodiments, the composition comprises non-ionic and anionic surfactants.

Surfactant can function as emulsifier, wetting agent, dispersing agent and combinations thereof.

In some embodiments, the amount of surfactant(s) in the composition is between 1-15% by weight based on the total weight of the composition.

In some embodiments, the amount of surfactant(s) in the composition is between 2-8% by weight based on the total weight of the composition.

In some embodiments, the surfactant is selected from a group consisting of polyalkylene glycol, polyalkylene glycol alkyl ether, polyalkylene glycol dialkyl ether, sodium alkyl sulphate, tristyrylphenol ethoxylate, a modified acrylic polymer, non-modified acrylic acid, alkyl sulfosuccinates, sulfonate and any combination thereof.

In some embodiments, the polyalkylene glycol alkyl ether is polyethylene glycol/polypropylene glycol (EO/PO) alkyl ether copolymer.

In some embodiments, the polyethylene glycol/polypropylene glycol (EO/PO) alkyl ether copolymer is random copolymer.

In some embodiments, the polyethylene glycol/polypropylene glycol (EO/PO) alkyl ether copolymer is block copolymer.

In some embodiments, the polyethylene glycol alkyl ether is polyethylene glycol alkyl ether.

In some embodiments, the tristyrylphenol ethoxylates is Soprophor 3D33, Soprophor 796/P, Makon TSP-40F and combination thereof.

A composition of the invention may also comprise two or more different surfactants.

In some embodiments, the composition further comprises polyelectrolyte complex.

In some embodiments, when the composition further comprises polyelectrolyte complex, the concentration of the polyelectrolyte complex in a composition according to the invention is 0.01-10% by weight based on the total weight of the composition.

In some embodiments, the composition further comprises an agriculturally acceptable inert additive.

In some embodiments, the agriculturally acceptable inert additive may include but is not limited to light stabilizers, UV absorbers, radical scavengers and antioxidants, adhesives, neutralizers, thickeners, binders, sequestrates, biocides, preservatives, and anti-freeze, drift retardants, pigments, safeners.

In some embodiments, the agriculturally acceptable inert additive is the thickener, biocide (preservative) anti foaming agent or combination thereof.

In some embodiments, the present invention provides a suspension concentrate comprising:
a. folpet in amount of about 35-45% w/w,
b. surfactant(s) in amount of about 4-10% w/w,
c. acetic acid in amount of about 0.45% w/w,
d. sodium acetate in amount of about 2.54% w/w and
e. water in amount of about 40% w/w

In some embodiments, the present invention provides a suspension concentrate comprising:
f. 41.8% w/w of folpet,
g. 2% w/w of Atlox 4913,
h. 0.45% w/w of Acetic acid
i. 2% w/w of Soprophor FL,
j. 3% w/w of propylene glycol.
k. 2.54%, w/w of sodium acetate
l. 0.64% w/w of Hexaethylene tetramine 99%,
m. 0.5% w/w of SAG 1572,
n. 7.4% w/w of a AgRH 2% and
o. 39.57% w/w of water.

### Acetic Acid-Based Buffer

Acetic acid-based buffers that may be used in connection with this invention are described below.

In some embodiments, the acetic acid-based buffer is obtained from mixing acetic acid and acetate agriculturally acceptable salt.

In some embodiments, the agriculturally acceptable salt is an alkali or alkaline earth metal salts such as sodium, potassium, lithium, magnesium, calcium, salts of other metals as copper, iron, zinc, cobalt, or nickel. In some embodiments, the salt contains ammonium group. In some embodiments the salt comprises substituted ammonium salts of any kind. salt form is in the form of alkali metal salts, alkaline earth metal salts and/or ammonium salts.

In some embodiments, the acetic acid-based buffer is obtained from mixing acetic acid and base different from acetate agriculturally acceptable salt.

In some embodiments, the acetic acid-based buffer is obtained from mixing acetate agriculturally acceptable salt with acid different from acetic acid.

In some embodiments, the composition comprises additional acid and/or base.

In some embodiments, the acetic acid-based buffer is obtained by mixing inorganic acid and/or stronger acid than acetic acid with acetic acid conjugate base (acetate agriculturally acceptable salt).

In some embodiments, the acetic acid-based buffer is obtained by mixing inorganic acid and/or stronger acid than acetic acid with acetic acid conjugate base (acetate agriculturally acceptable salt). In some embodiments, the acetic acid-based buffer is obtained by using a base selected from inorganic base, organic base and combination thereof.

In some embodiments the base is sodium hydroxide.

In some embodiments, the base is K₂HPO₄.

In some embodiments, the base is a weak base such as carbonate salts, phosphate (K₂HPO₄) and combination thereof.

Alkali metal carbonates, alkali metal bicarbonates, alkyl metal percarbonate, Alkali metal orthophosphates, Alkali metal pyrophosphates and combination thereof.

In some embodiments, additional acid can be added such as fumaric acid and KH₂PO₄.

### Use of Acetic Acid-Based Buffer

The present invention provides the use of acetic acid-based buffer for maintaining the pH of a composition comprising phthalimide fungicide above 4 during storage.

The present invention provides an acetic acid-based buffer for use in maintaining the pH of a composition comprising phthalimide fungicide above 4 during storage.

The present invention also provides a method for stabilizing a composition comprising phthalimide fungicide, the method comprises formulating the phthalimide in the presence of acetic acid-based buffer.

### Polyelectrolyte Complex

In some embodiments, the composition of the present invention comprises a polyelectrolyte complex.

In some embodiments, the polyelectrolyte complex is as described in WO 2013/133705 and WO 2013/133706.

In some embodiments, the polyelectrolyte complex is a complex of a polycation and a polyanion.

A non-bioactive polycation is preferably or comprises cationic starch, poly(allylamine), chitosan, a chitosan derivative such as thiolated chitosan, 5-methyl-pyrrolidinone-chitosan, and chitosan oligosaccharide, epsilon-p-L-lysine, DEAE-dextran, or mixtures thereof. Preferably, said non-bioactive polycation is selected from the group consisting of cationic starch, poly(allylamine), chitosan and chitosan derivatives. Preferably, said non-bioactive polycation is poly(allylamine). Preferably, said non-bioactive polycation is chitosan.

In some embodiments, the preferred polycation in a polyelectrolyte complex according to the invention is cationic derivative of starch, poly(allylamine), chitosan, epsilon-poly(L-lysine), chitosan derivatives such as thiolated chitosan, 5-methyl-pyrrolidinone-chitosan and chitosan oligosaccharide and/or DEAE-dextran.

In some embodiments, the preferred polyanion in a polyelectrolyte complex according to the invention is a negatively charged derivative of natural origin, for example, xanthan gum, alginate, a lignin compound such as lignosulfonate, pectin, carrageenan, humic acid, fulvic acid, angico gum, gum Kondagogu, sodium alkyl naphthalene sulfonate (Morwet), poly-γ-glutamic acid, maleic starch half-ester, carboxymethyl cellulose, dextran sulphate, hyaluronic acid, poly(acrylic acid), polyphosphoric acid, poly(L-lactide), polyglycolide, sodium (Na) humate, and/or chondroitin sulfate (CS).

In some embodiments, the polycation is selected from the group consisting of chitosan (CTS), epsilon-poly-L-lysine (ϵ-PLL), poly allyl amine (PAA), and any mixture thereof. In some embodiments, the polycation is chitosan (CTS). In some embodiments, the polycation is poly allyl amine (PAA). In some embodiments, the polycation is epsilon-poly-L-lysine (ϵ-PLL).

In some embodiments, the polycation is chitosan, epsilon-poly (L-lysine), PAA or any combination thereof.

In some embodiments, the polycation is chitosan and/or poly allyl amine (PAA).

In some embodiments, the polycation is chitosan, poly allyl amine (PAA) and combination thereof.

In some embodiments, the polycation is chitosan.

In some embodiments, the polycation is PAA.

A non-bioactive polyanion is preferably of natural origin, for example xanthan gum, alginate, pectin, a lignin compound such as lignosulfonate, carrageenan, humic acid, fulvic acid, angico gum, gum Kondagogu, sodium alkyl naphthalene sulfonate, poly-y-glutamic acid, maleic starch half- ester, carboxymethyl cellulose, chondroitin sulphate, dextran sulphate, or hyaluronic acid, or of synthetic origin, for example poly(acrylic acid), polyphosphoric acid, and poly(L-lactide), or a mixture thereof, to form a polyelectrolyte complex with a non-bioactive polycation. Preferably, said non-bioactive polyanion is selected from the group consisting of xanthan gum, alginate sodium (Na), chondroitin sulfate (CS), lignosulfonate and any combination thereof. Most preferably, said non-bioactive polyanion comprises or is lignosulfonate.

In some embodiments, the polyanion is lignosulfonate.

In some embodiments, the polyanion of the polyelectrolyte complex is lignosulfonate and the dispersant of the aqueous composition is also lignosulfonate.

In some embodiments, the concentration of the polyanion in the composition is less than 5% by weight based on the total weight of the composition. In some embodiments, the concentration of the polyanion in the composition is less than 3% by weight based on the total weight of the composition. In some embodiments, the concentration of the polyanion in the composition is less than 2.5% by weight based on the total weight of the composition. In some embodiments, the concentration of the polyanion in the composition is less than 2% by weight based on the total weight of the composition. In some embodiments, the concentration of the polyanion in the composition is less than 1.5% by weight based on the total weight of the composition. In some embodiments, the concentration of the polyanion in the composition is less than 1% by weight based on the total weight of the composition. In some embodiments, the concentration of the polyanion in the composition is less than 0.5% by weight based on the total weight of the composition.

Sodium (Na) humate, a water-soluble Na salt of humic acid derived from leonardite (an oxidation product of lignite), was chosen as the preconditioning polyelectrolyte. Na humate is a commercially available low-cost material that is increasingly used in biological farming as a soil conditioner, and also to stimulate plant growth.

Sodium humate forms complexes/chelates with cationic dye/metal ions due to the presence of these carboxylate and phenolate groups.

Chondroitin sulfate (CS) is one of the natural glycosaminoglycans (GAG) composed of the alternating sugars D-glucuronic acid (GlcA) and N-acetyl-D-galactosamine (GalNAc). It is an important component of the extracellular complex (ECM). Due to the negative charge of CS is considered a strong polyelectrolyte.

In some embodiments, the complex is characterized by a non-covalent intermolecular interactions, preferably ionic interaction and hydrogen bonds between donor and acceptor groups of said polycation and said polyanion.

The polyelectrolyte complex is prepared by mixing at least one polyanion and at least one polycation.

In some embodiments, the polycation is protonated prior to interaction with the polyanion.

In some embodiments, the polyanion is prepared prior to the interaction with the polycation. In some embodiments, the polyelectrolyte complex is prepared as described in WO2013/133705 and WO2013/133706.

In some embodiments, the polycation in the polyelectrolyte complex is chitosan.

In some embodiments, the polycation in the polyelectrolyte complex is PAA.

In some embodiments, the concentration of chitosan in the polyelectrolyte complex is about 0.5% by weight based on the total weight of the composition.

In some embodiments, the concentration of PAA in the polyelectrolyte complex is about 0.5% by weight based on the total weight of the composition.

In some embodiments, the concentration of chitosan in the polyelectrolyte complex is about 0.9% by weight based on the total weight of the composition.

In some embodiments, the concentration of PAA in the polyelectrolyte complex is about 1% by weight based on the total weight of the composition.

In some embodiments, the concentration of the polyanion used for the polyelectrolyte complex is 0.01-10% by weight based on the total weight of the composition. In some embodiments, the concentration of the polyanion used for the polyelectrolyte complex is 0.01-8% by weight based on the total weight of the composition. In some embodiments, the concentration of the polyanion used for the polyelectrolyte complex is 0.1-5% % by weight based on the total weight of the composition.

In some embodiments, the concentration of lignosulfonate in the polyelectrolyte complex is less than 5% by weight based on the total weight of the composition.

In some embodiments, the concentration of lignosulfonate in the polyelectrolyte complex is less than 2.5% by weight based on the total weight of the composition.

In some embodiments, the concentration of lignosulfonate in the polyelectrolyte complex is less than 2% by weight based on the total weight of the composition.

In some embodiments, the concentration of lignosulfonate in the polyelectrolyte complex is less than 1.5% by weight based on the total weight of the composition.

In some embodiments, the weight ratio between the polyanion and polycation used for the polyelectrolyte complex is between 10:1 to 1:2. In some embodiments, the weight ratio between the polyanion and polycation used for the polyelectrolyte complex is between 8:1 to 2:1. In some embodiments, the weight ratio between the polyanion and polycation used for the polyelectrolyte complex is between 5:1 to 2:1. In some embodiments, the weight ratio between the polyanion and polycation used for the polyelectrolyte complex is 5:1. In some embodiments, the weight ratio between the polyanion and polycation used for the polyelectrolyte complex is 2:1.

In some embodiments, the weight ratio between the cationic polyelectrolyte and the anionic polyelectrolyte in the composition is in the range of 2:1 to 1:10. In some embodiments, the weight ratio between the cationic polyelectrolyte and the anionic polyelectrolyte in the composition is in the range of 1:1 to 1:7. In some embodiments, the weight ratio between the cationic polyelectrolyte and the anionic polyelectrolyte in the composition is in the range of 1:2 to 1:5.

In some embodiments the weight ratio between the polycation and polyanion is 1:5. In some embodiments the weight ratio between the polycation and polyanion is 1:2.

In some embodiments, the concentration of the polycation in the polyelectrolyte complex is 0.01-10% by weight based on the total weight of the composition. In some embodiments, the concentration of the polycation in the polyelectrolyte complex is 0.1-5% by weight based on the total weight of the composition. In some embodiments, the concentration of the polycation in the polyelectrolyte complex is 0.1-1.5% by weight based on the total weight of the composition. In some embodiments, the concentration of the polycation in the polyelectrolyte complex is about 0.5% by weight based on the total weight of the composition. In some embodiments, the concentration of the polycation in the polyelectrolyte complex is about 1% by weight based on the total weight of the composition.

Acids are used to obtain dissolution of some polycation. For example, chitosan is an aminoglycan consisting of beta-(1right4)-linked D-glucosamine residues. In acidic environment, global protonation of the 2-amino groups creates cationic chitosan.

In some embodiments, an acid is used to solubilize the polycation.

In some embodiments, the acid has a pKa lower than 5.

### Inert Additives

In some embodiments, the composition comprises at least one agriculturally acceptable additive.

In some embodiments, the composition comprises an anti-foam agent.

An anti-foam agent, when present, is preferably selected from polymethylsiloxane, polydimethylsiloxane, simethicone octanol, and silicone oils. A composition of the invention may also comprise two or more different anti-foam agents. An anti-foam agent is preferably present in an amount of between 0 to up to 10% (w/v), more preferred between 0.05 to up to 5% (w/v), more preferred between 0.1 to up to 1% (w/v), more preferred about 0.5% (w/v).

In some embodiments, the anti-foam agent is silicone-based.

In some embodiments, the concentration of the anti-foam forming agent is 0.01-5% by weight based on the total weight of the composition. In some embodiments, the concentration of the anti-foam forming agent is 0.1-1% by weight based on the total weight of the composition. In some embodiments, the concentration of the anti-foam forming agent is about 0.4% by weight based on the total weight of the composition. In some embodiments, the concentration of the anti-foam forming agent is about 0.5% by weight based on the total weight of the composition.

In some embodiments, the composition comprises at least one antifreezing agent. In some embodiments, the agriculturally acceptable additive is an antifreezing agent.

An antifreezing agent, when present, is preferably selected from glycerine, ethylene glycol, hexyleneglycol and propylene glycol. A composition of the invention may also comprise two or more different antifreezing agents. An antifreezing agent is preferably present in an amount of between 0 to up to 10% (w/v), more preferred between 0.01 to up to 5% (w/v), more preferred between 2 to up to 5% (w/v), more preferred about 4% (w/v).

In some embodiments, the antifreezing agent is propylene glycol.

In some embodiments, the concentration of the antifreezing agent in the composition is 1-10% by weight based on the total weight of the composition. In some embodiments, the concentration of the antifreezing agent in the composition is 1-5% by weight based on the total weight of the composition. In some embodiments, the concentration of the antifreezing agent in the composition is about 4% by weight based on the total weight of the composition. In some embodiments, the concentration of the antifreezing agent in the composition is about 5% by weight based on the total weight of the composition.

In some embodiments, the composition comprises at least one rheology modifier. In some embodiments, the agriculturally acceptable additive is a rheology modifier.

In some embodiments, the concentration of the rheology modifier in the composition is 0.1-10% by weight based on the total weight of the composition.

In some embodiments, the rheology modifier is a thickener. In some embodiments, the composition comprises at least one thickener.

A thickening agent, when present, is preferably selected from agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the concentration of the rheology modifier in the composition is 0.05-10% by weight based on the total weight of the composition. In some embodiments, the concentration of the rheology modifier in the composition is 0.1-5% by weight based on the total weight of the composition. In some embodiments, the concentration of the rheology modifier in the composition is 0.2-1% by weight based on the total weight of the composition. In some embodiments, the concentration of the rheology modifier in the composition is about 2.5% by weight based on the total weight of the composition. In some embodiments, the concentration of the rheology modifier in the composition is about 0.1% by weight based on the total weight of the composition.

In some embodiments, the composition comprises at least one thickener and at least one biocide. In some embodiments, the amount of the thickener and the biocide in the composition is up to 0.2% by weight based on the total weight of the composition.

In some embodiments, the agriculturally acceptable additive is a preservative. In some embodiments, the composition comprises at least one preservative.

In some embodiments, the preservative is a biocide. In some embodiments, the composition comprises at least one biocide.

In some embodiments, the concentration of the preservative in the composition is 0.01-5% by weight based on the total weight of the composition. In some embodiments, the concentration of the preservative in the composition is 0.01-1% by weight based on the total weight of the composition. In some embodiments, the concentration of the preservative in the composition is about 0.1% by weight based on the total weight of the composition.

### Additional Bioactive Ingredients

Various agrochemicals may be used as additional bioactive ingredients. Exemplary among such agrochemicals without limitation are crop protection agents, for example pesticides, safeners, plant growth regulators, repellents, bio-stimulants and preservatives such as bacteriostats or bactericides.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients.

Said additional bioactive ingredient preferably is an insecticide, a fungicide and/or an herbicide.

In some embodiments, the composition comprises at least one additional bioactive ingredient, preferably an additional insecticide, fungicide and/or herbicide.

In some embodiments, the additional bioactive ingredient is fluxapyroxad.

In some embodiments, the additional fungicide as described in WO/2022/009154, the entire content of which is hereby incorporated by reference.

An additional fungicide includes but not limited to multi-site contact fungicide, QiI fungicide (quinone inside inhibitors), QoI fungicide (quinone outside inhibitors) QoSI fungicide (quinone outside stigmatellin subsite inhibitors), SDHI fungicide (succinate dehydrogenase inhibitors), Demethylation Inhibitor fungicide, phenyl amide fungicide, methyl-benzimidazole-carbamate (MBC) fungicide, carboxylic acid amide fungicide, benzamide fungicide, natural fungicide, anilinopyrimidine fungicide, hydroxy-(2-amino)-pyrimidines fungicide, phosphonate fungicide, plant extract fungicide, Keto-Reductase inhibitor fungicide, phenylpyrrole fungicide (PP), aryl phenyl-ketone fungicide, amine fungicide, dinitro aniline fungicide, azanaphthalene fungicide, benzothiadiazole fungicide, carbamate fungicide, cyanoacetamideoxime fungicide, dinitrophenyl-crotonate fungicide, glucopyranosyl antibiotic fungicide, tetrazolyloxime fungicide, thiazolidine fungicide, oxysterol binding protein inhibitor (OSBPI) fungicide, thiophenecarboxamide fungicide, phenylacetamide fungicide, phenyl urea fungicide, polyene fungicide, pyr-hydrazone fungicide, pyrimidinamine fungicide, pyrimidinone fungicide, fungicide (B) and any combination thereof.

Additional fungicide includes but not limited to fluxapyroxad, mancozeb, sodium ortho-phenylphenate, 2-phenylphenol; 8-hydroxyquinoline sulphate; acibenzolar-5-methyl; actinovate; aldimorph; amidoflumet; ampropylfos; ampropylfos-potassium; andoprim; anilazine; azoxystrobin; benalaxyl; benodanil; benomyl (methyl 1-(butylcarbamoyl)benzimidazol-2-ylcarbamate); benthiavalicarb-isopropyl; benzamacril; benzamacril-isobutyl; bilanafos; binapacryl; biphenyl; blasticidin-S; boscalid; bupirimate; buthiobate; butylamine; calcium polysulphide; capsimycin; carbendazim; carboxin; carpropamid; carvone; chinomethionat; chlobenthiazone; chlorfenazole; chloroneb; chlorothalonil; chlozolinate; cis-1-(4-chlorophenyl)-2-(1H-1,2,4-triazol-1-yl)-cycloheptanol; clozylacon; a conazole fungicide such as, for example, (RS)-1-(β-allyloxy-2,4-dichlorophenethyl)imidazole (imazalil; Janssen Pharmaceutica NV, Belgium) and N-propyl-N-[2-(2,4,6-trichlorophenoxy)ethyl] imidazole-1-carboxamide (prochloraz); cyazofamid; cyflufenamid; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dinocap; diphenylamine; dipyrithione; ditalimfos; dithianon; dodine; drazoxolon; edifenphos; ethaboxam; ethirimol; etridiazole; famoxadone; fenamidone; fenapanil; fenfuram; fenhexamid; fenitropan; fenoxanil; fenpiclonil; fenpropidin; fenpropimorph; fluazinam (3-chloro-N-(3-chloro-5-trifluoromethyl-2-pyridyl)-α,α,α-trifluoro-2,6-dinitro-p-toluidine); flubenzimine; fludioxonil; flumetover; flumorph; fluoromide; fluoxastrobin; flurprimidol; flusulfamide; flutolanil; fosetyl-A1; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprodione; iprovalicarb; irumamycin; isoprothiolane; isovaledione; kasugamycin; kresoxim-methyl; mandipropamid, meferimzone; mepanipyrim; mepronil; metalaxyl; metalaxyl-M; methasulfocarb; methfiroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]-methyl]-alph-a.-(methoxymethylene)benzeneacetate; methyl 2-[2-[3-(4-chlorophenyl)-1-methyl-allylideneaminooxymethyl]phenyl]-3-meth-oxyacrylate; metiram; metominostrobin; metrafenone; metsulfovax; mildiomycin; monopotassium carbonate; myclozolin; N-(3-ethyl-3,5,5-trimethylcyclohexyl)-3-formylamino-2-hydroxybenzamide; N-(6-methoxy-3-pyridinyl cyclopropanecarboxamide; a polyene fungicide such as natamcyin; N-butyl-8-(1,1-dimethylethyl)-1-oxaspiro[4.5] decan-3-amine; nitrothal-isopropyl; noviflumuron; ofurace; orysastrobin; oxadixyl; oxolinic acid; oxycarboxin; oxyfenthiin; pencycuron; penthiopyrad; phosdiphen; phosphite salts such as disodium phosphite and potassium phosphite, phthalide; picobenzamid; picoxystrobin; piperalin; polyoxins; polyoxorim; procymidone; propamocarb; propanosine-sodium; propineb; proquinazid; pyraclostrobin; pyrazophos; pyrimethanil; pyroquilon; pyroxyfur; pyrrolnitrine, quinconazole; quinoxyfen; quintozene; silthiofam; sodium tetrathiocarbonate; spiroxamine; sulphur; tecloftalam; tecnazene; tetcyclacis; thiazole fungicide such as, for example, 2-(thiazol-4-yl)benzimidazole (thiabendazole), thicyofen; thifluzamide; thiophanate-methyl; tiadinil; tioxymid; tolclofos-methyl; tolylfluanid; triazbutil; triazoxide; tricyclamide; tricyclazole; tridemorph; trifloxystrobin; validamycin A; vinclozolin; zoxamide; (2S)-N-[2-[4-[[3-(4-chlorophenyl)-2-propynyl]oxy]-3-methoxyphenyl]ethyl]-3-met-hyl-2-[(methylsulphonyl)amino]butanamide; 1-(1-naphthalenyl)-1H-pyrrole-2,5-dione; 2,3,5,6-tetrachloro-4-(methylsulphonyl)pyridine; 2,4-dihydro-5-methoxy-2-methyl-4-[[[[1-[3-(trifluoromethyl)phenyl]-ethyli-dene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxam-ide; 3,4,5-trichloro-2,6-pyridinedicarbonitrile; 3-[(3-bromo-6-fluoro-2-methyl-1H-indol-1-yl)sulphonyl]-N,N-dimethyl-1H-1,-2,4-triazole-1-sulphonamide, and/or mixtures thereof.

In some embodiments, the composition of the present invention is combined with two additional fungicides. In some embodiments, the composition of the present invention is combined with fluxapyroxad.

An additional insecticide is a carbamate such as carbofuran, propoxur, methomyl, bendiocarb, formetanate, oxamyl, and aldicarb, an organochlorine such as methoxychlor, kelthane, lindane, toxaphene, and cyclodiene insecticides such as aldrin, dieldrin, endrin, mirex, chlordane, heptachlor, and endosulfan, an organophosphate such as parathion, malathion, methyl parathion, chlorpyrifos, diazinon, dichlorvos, phosmet, fenitrothion, tetrachlorvinphos, azamethiphos, azinphos-methyl, and terbufos, a formamidine such as amitraz, chlordimeform, formetanate, formparanate, medimeform, and semiamitraz, an organosulfur such as dipymetitrone, an avermectin such as ivermectin, doramectin, selamectin, milbemycin oxime and moxidectin, a neonicotinoid such as acetamiprid, clothianidine, imidacloprid, nitenpyram, nithiazine, thiacloprid and thiamethoxam and/or a pyrethroid insecticide such as allethrin,, bifenthrin, cyfluthrin, cypermethrin, cyphenothrin, deltamethrin, esfenvalerate, etofenprox, fenpropathrin, fenvalerate, flucythrinate, flumethrin, fmiprothrin, lambda-cyhalothrin, metofluthrin, permethrin, resmethrin, silafluofen, sumithrin, tau-fluvalinate, tefluthrin, tetramethrin, tralomethrin, and transfluthrin In some embodiments, the composition is substantially free of an agriculturally acceptable organic solvent. In some embodiments, the composition is aqueous.

A composition according to the invention may comprise an additional bioactive ingredient, also termed additional agrochemical, such as a growth regulator, a bio-stimulant, a fungicide, an herbicide, an insecticide, an acaricide, a molluscicide, a miticide, a rodenticide; and/or a bactericide.

In some embodiments, the composition is tank mixed with an additional agrochemical. In some embodiments, the composition is applied sequentially with the additional agrochemical. In some embodiments, the composition is applied simultaneously with the additional agrochemical.

### Methods for Preparation of an Aqueous Suspension Concentrate Composition

The invention further provides a process for preparing a composition according to the present invention, wherein the process comprises suspending the phthalimide fungicide in water comprising at least one surfactant.

In some embodiments, acetic acid-based buffer is added to the water prior to addition of the phthalimide.

In some embodiments, the acetic acid-based buffer is added after the phthalimide fungicide.

In some embodiments, the acetic acid-based buffer is added before milling the composition.

In some embodiments, the acetic acid buffer is added after milling.

In some embodiments, acid and base, two components used for preparing the acetic acid-based buffer, are added separately. One is before and one is after the phthalimide addition, and/or milling.

When the composition further comprises polyelectrolyte complex, the process comprising (a) preparing an aqueous composition of a polyelectrolyte complex, (b) adding at least one surfactant, (c) mixing a phthalimide fungicide into the aqueous composition.

In some embodiments, acetic acid-based buffer is added to the water prior to addition of the phthalimide.

In some embodiments, the acetic acid-based buffer is added after the phthalimide fungicide.

In some embodiments, the acetic acid-based buffer is added before milling the composition.

In some embodiments, the acetic acid buffer is added after milling.

In some embodiments, acid and base, two components used for preparing the acetic acid-based buffer, are added separately. One is before and one is after the addition of the phthalimide, and/or milling.

In some embodiments, the phthalimide is milled separately from the polyelectrolyte complex

In some embodiments, the phthalimide is milled in the presence of the polyelectrolyte complex.

In some embodiments, when the composition comprises additional active ingredient the additional active ingredient(s) can be added before and after milling of the phthalimide fungicide.

Said methods or processes for producing a composition according to the invention may further comprise a step of milling or grinding the resultant composition to reduce their particle size to an average particle size (volume based) d50 below 2 microns.

### Methods of Use

The invention also provides a method of treating a plant, or a part of a plant, against a pathogen, comprising contacting the plant, or part of the plant, with a composition described herein.

In some embodiments, the method comprises protecting the plant, or a part of a plant, against the pathogen, comprising contacting the plant, or part of the plant, with the composition described herein.

In some embodiments, the method comprises preventing, reducing and/or eliminating the presence of the pathogen on the plant, or part of the plant, comprising contacting the plant, or part of the plant, with the composition described herein.

In some embodiment, the method of treating the plant, or the part of a plant against a pathogen comprises controlling diseases caused by phytopathogenic fungi in plants or on propagation material thereof, which method comprises contacting the plants, or propagation material thereof, with the composition described herein.

The present invention provides a method of controlling a disease caused by phytopathogenic fungi on plants or propagation material thereof, comprising contacting the plants, the locus thereof or propagation material thereof with at least one of the herein defined compositions.

The present invention also provides a method of controlling pest comprising contacting (i) the pest or a locus thereof, (ii) a plant or a locus or propagation material thereof, (iii) soil, and/or (iv) an area in which pest infestation is to be prevented with a composition of the invention.

The present invention also provides a method of controlling or preventing pest comprising contacting (i) the pest or a locus thereof, (ii) a plant or a locus or propagation material thereof, (iii) soil, and/or (iv) an area in which pest infestation is to be controlled or prevented with a composition of the invention.

The present invention provides a method of treating a plant, or a part of a plant, against a pathogen, comprising contacting the plant, or part of the plant, with any one of the compositions described herein.

The present invention also provides a method of preventing, reducing and/or eliminating the presence of a pathogen on a plant, or a part of a plant, comprising contacting said plant, or part of said plant, with any one of the compositions described herein.

In some embodiments, the plant part is leaf.

The present invention also provides a method of controlling diseases caused by phytopathogenic fungi in plants or on propagation material thereof which comprises contacting the plants, or propagation material thereof, with any one or any combination the compositions described herein.

In some embodiments, the target is a plant. In some embodiments, the target is a pest. In some embodiments, the pest is a fungus.

The described compositions may be applied to healthy or diseased plants. The described compositions can be used on various plants including but not limited to crops, seeds, bulbs, propagation material, or ornamental species.

To control agricultural pests, the invention provides a use of a composition according to the invention for the protection of a plant, or a part of a plant, against a pathogen. In order to achieve this effect, said plant or plant part, or a soil, is contacted with said composition, including a diluted aqueous composition.

The present invention provides use of any one of the compositions described herein for the protection of a plant, or a part of a plant, against a pathogen.

The present invention provides any one of the compositions described herein for use in protecting a plant, or a part of a plant, against a pathogen.

In some embodiments, the composition is sprayed over a plant or a part of a plant.

In some embodiments, the plant part is seed or fruit.

A composition according to the invention is suitable for the control of pests that are encountered in horticulture, agriculture, and forestry. The composition is active against normally sensitive and resistant pest species and during all or individual stages of development. Prior to use, a composition of the present invention is preferably dissolved or dispersed in water, or diluted with water, to provide an aqueous composition.

In some embodiments, the phthalimide fungicide is applied at a rate from 0.1 grams of total active ingredient per hectare (g a.i./ha) to 10000 g a.i./ha. In some embodiments, the phthalimide fungicide is applied at a rate from about 10 g a.i./ha to about 10000 g a.i./ha. In some embodiments, the phthalimide fungicide is applied at a rate from about 50 g a.i./ha to about 5000 g a.i./ha. In some embodiments, the phthalimide fungicide is applied at a rate from about 50 g a.i./ha to about 2600 g a.i./ha. In some embodiments, the phthalimide fungicide is applied at a rate from about 100 g a.i./ha to about 2500 g a.i./ha. In some embodiments, the phthalimide fungicide is applied at a rate from about 50 g a.i./ha to about 2000 g a.i./ha. In some embodiments, the phthalimide fungicide is applied at a rate from about 25 g a.i./ha to about 2000 g a.i./ha. In some embodiments, the phthalimide fungicide is applied at a rate from about 100 g a.i./ha to about 750 g a.i./ha. In an embodiment, the phthalimide fungicide is applied at a rate from about 60 g a.i./ha to about 600 g a.i./ha. In some embodiments, the phthalimide fungicide is applied at a rate from about 100 g a.i./ha to about 200 g a.i./ha. In some embodiments, the phthalimide fungicide is applied at a rate from about 100 g a.i./ha to about 130 g a.i./ha.

The application rates for phthalimide fungicide are generally from 1 to 5000 g/ha, preferably from 10 to 2500 g/ha, in particular from 20 to 1000 g/ha. In some embodiments, the application rates of phthalimide fungicide may be from 400 to 1500 g/ha. In some embodiments, the application rates of phthalimide fungicide may be from 500 to 1500 g/ha. In some embodiments, the phthalimide fungicide is applied at a rate between 500 to 1000 g/ha. In some embodiments, the phthalimide fungicide is applied at a rate between 700 to 800 g/ha. In some embodiments, the phthalimide fungicide is applied at a rate of 750 g/ha. In some embodiments, the phthalimide fungicide is applied at a rate between 450 to 550 g/ha. In some embodiments, the phthalimide fungicide is applied at a rate of 500 g/ha.

In some embodiments, the phthalimide fungicide, if applied as foliar application, is to be applied at a rate between 500 to 1500 g/ha. In some embodiments, the phthalimide fungicide is applied at a rate of about 1500 g a.i./ha. In some embodiments, the phthalimide fungicide is applied at a rate of about 1200 g a.i./ha. In some embodiments, the phthalimide fungicide is applied at a rate of about 1000 g a.i./ha. In some embodiments, the phthalimide fungicide is applied at a rate of about 900 g a.i./ha. In some embodiments, the phthalimide fungicide is applied at a rate of about 750 g a.i./ha. In some embodiments, the phthalimide fungicide is applied at a rate of about 600 g a.i./ha. In some embodiments, the phthalimide fungicide is applied at a rate of about 500 g a.i./ha.

In some embodiments, the phthalimide fungicide, if applied as foliar application, is to be applied at a rate between 20 to 300 g a.i./hL. In some embodiments, the phthalimide fungicide is applied at a rate of about 150 g a.i./hL. In some embodiments, the phthalimide fungicide is applied at a rate of about 120 g a.i./hL. In some embodiments, the phthalimide fungicide is applied at a rate of about 100 g a.i./hL. In some embodiments, the phthalimide fungicide is applied at a rate of about 90 g a.i./hL. In some embodiments, the phthalimide fungicide is applied at a rate of about 75 g a.i./hL. In some embodiments, the phthalimide fungicide is applied at a rate of about 60 g a.i./hL. In some embodiments, the phthalimide fungicide is applied at a rate of about 50 g a.i./hL. In some embodiments, the phthalimide fungicide is applied at a rate of about 30 g a.i./hL. In some embodiments, the phthalimide fungicide is applied at a rate of about 25 g a.i./hL. In some embodiments, the phthalimide fungicide is applied at a rate of about 20 g a.i./hL. In some embodiments, the phthalimide fungicide is applied at a rate of about 10 g a.i./hL.

In some embodiments, the phthalimide fungicide, if applied as soil application, is to be applied at a rate between 0.1 to 10000 g/ha. In some embodiments, the phthalimide fungicide, if applied as soil application, is to be applied at a rate between 1 to 5000 g/ha. In some embodiments, the phthalimide fungicide, if applied as soil application, is to be applied at a rate between 60 to 2600 g/ha.

In some embodiments, the composition according to the invention is diluted 2-5000 times.

To control agricultural pests, the invention provides a use of a composition according to the invention for the protection of a plant, or a part of a plant, against a pathogen. In order to achieve this effect, said plant or plant part, or a soil, is contacted with said composition, including a diluted aqueous composition.

In some embodiments, the pathogen is one of Leaf Blotch of Wheat (Mycosphaerella graminicola; anamorph: Septoria tritici), Wheat Brown Rust (Puccinia triticina), Stripe Rust (Puccinia striiformis f. sp. tritici), Scab of Apple (Venturia inaequalis), Blister Smut of Maize (Ustilago maydis), Powdery Mildew of Grapevine (Uncimila necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f. sp. tritici), Powdery Mildew of Barley (Blumeria graminis f. sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), and Net Blotch of Barley (Pyrenophora teres).

For said use and said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, the composition, including a diluted aqueous composition, may be injected into the soil.

For example, a plant of part thereof may be coated with a diluted aqueous composition comprising a phthalimide fungicide according to the invention by submerging the plant or part thereof in a diluted aqueous composition to protect the plant of part thereof against a pathogen and/or to prevent, reduce and/or eliminate the presence of a pathogen on a plant, or a part of a plant. A preferred part of a plant that is coated with a composition according to the invention, or with a dilution thereof, is seed. A further preferred part of a plant that is coated with a composition according to the invention, or with a dilution thereof, is leaf. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

In some embodiments, the pesticide is applied at a rate effective for controlling a pest. In some embodiments, the pesticide is applied at a rate effective for preventing infestation of the pest. In some embodiments, the pesticide is applied at a rate effective for curing infestation of the pest.

In some embodiments, a method of the invention is effective for preventing infestation of a pest. In some embodiments, the method is effective for curing infestation of the pest. In some embodiments, the method is effective for increasing the pesticidal activity of the pesticide, wherein the pesticide is phthalimide fungicide.

In some embodiments, a method of the invention further comprises applying at least one additional agrochemical to a pest, a plant part, a plant, the locus, or propagation material thereof.

In some embodiments, the composition is tank mixed with an additional agrochemical. In some embodiments, the composition is applied sequentially with the additional agrochemical.

In some embodiments, the composition is tank mixed with an additional adjuvant. In some embodiments, the composition is applied sequentially with an additional adjuvant.

Each embodiment disclosed herein is contemplated as being applicable to each of the other disclosed embodiments. Thus, all combinations of the various elements described herein are within the scope of the invention. In addition, the elements recited in composition embodiments can be used in the composition, method, use and process embodiments described herein and vice versa.

The invention is illustrated by the following examples without limiting it thereby.

### 4. EXPERIMENTAL SECTION

Method: pH stability of the concentrated composition was measured before and after storage

### Example 1, Acetic Acid-Based Buffer

TABLE 1

| | % w/w |
|---|---|
| Folpet Tech | 41.80 |
| Atlox 4913 | 2 |
| Soprophor FL | 2 |
| Propylene glycol | 3 |
| Acetic acid | 0.45 |
| sodium acetate | 2.54 |
| Hexaethylene | 0.64 |
| tetramine 99% | |
| SAG 1572 | 0.5 |
| 2% AgRH | 7.4 |
| Water | Up to 100% |

### Preparation Procedure

Charge soft water to vessel. Add Acetic acid and sodium acetate to the vessel and mix until the solution is homogenous. Add HMTA to the vessel and mix until the solution is homogenous.

Add Atlox 4913, Soprophor FL, Anti Foam (half the amount) and Propylene Glycol and mix until the solution is homogenous.

Slowly charge the technical Folpet while shearing with high shear until the solution is homogenous.

Milling the dispersion.

Add the remaining anti-foam.

Add AG RH23 2% solution and remaining water to the mixture while mixing.

### pH Stability

TABLE 2

| | pH |
|---|---|
| After 2 weeks at room | 5.25 |
| temperature (25° C. ± 5) | |
| After 2 weeks at | 4.47 |
| temperature of 54° C. (OVEN) | |

### Example 2, Comparative Test, Fumaric Acid-Based Buffer

TABLE 3

| | Quantity (Kg) for |
|---|---|
| Raw Material | 100 liters |
| Captan tech | 50.0 Kg |
| Tensiofix 35300 | 1.0 Kg |
| Hostapon TPHC | 1.2 kg |
| Geropon T/36 DF | 0.7 kg |
| HexaMethylene | 5.0 Kg |
| TetraAmine | |
| Rhodorsil 432 | 0.2 Kg |
| Fumaric acid | 0.54 kg |
| Propylene Glycol | 5.0 Kg |
| NaOH (15%) | 2.35 kg |
| Xanthan Gum AGRH 23 | 12.0 Kg |
| 2.3% solution | |
| Soft Water | up to 100 liter |

### Preparation Procedure

Stage 1 preparation of buffer solution pH 5.5: Charge Soft Water to the vessel. Add Fumaric acid to the vessel and mix until the solution is homogenous. Slowly charge HexaMethylene TetraAmine (HMTA) and add NaOH 15% solutions.

Stage 2: Mixing: Add Tensiofix 35300, Hostapon TPHC, Anti Foam and Propylene Glycol and mix until the solution is homogenous. Slowly charge the Captan tech. while shearing with high shear until the solution is homogenous.

Stage 4 Milling, transfer and Washing. Mill the dispersion in until d90<6 mm.

10 Stage 5. Add anti foam solution, Geropon T/36 DF and Xanthan Gum AGRH 23 2%, test the viscosity and A.I. concentrations.

pH stability:

TABLE 4

| | pH |
|---|---|
| After 2 weeks at room | 5.05 |
| temperature (25° C. ± 5) | |
| After 2 weeks at | 3.0 |
| temperature of 54° C. (OVEN) | |

1. A composition comprising a phthalimide fungicide and an acetic acid-based buffer comprising acetic acid and acetic acid conjugate base.

2. The composition of claim 1, wherein the composition is an aqueous based composition.

3. The composition of claim 2, wherein the composition comprises (1) an amount of the phthalimide fungicide, (2) an amount of the acetic acid-based buffer, and (3) water, wherein the phthalimide is suspended in the water.

4. The composition of claim 1, wherein:
a) the composition is a concentrated composition, a suspension concentrate, or a suspoemulsion composition,
b) the phthalimide fungicide is folpet, captan, or captafol,
c) the concentration of the phthalimide fungicide is between 0.1% to 99% by weight,
d) the concentration of the acetic acid in the composition is up to 5% by weight based on the total weight of the composition, and/or the concentration of the acetic acid in the buffer is up to 25% by weight based on the total weight of the buffer,
e) the concentration of the acetic acid conjugate base in the composition is up to 5% by weight based on the total weight of the composition, and/or the concentration of the acetic acid conjugate base in the buffer is up to 85% by weight based on the total weight of the buffer,
f) the weight ratio between the phthalimide fungicide and the acetic acid-based buffer is between 200:1 to 6:1,
g) the acetic acid conjugate base is an agriculturally acceptable acetate salt,
h) the composition is stable, and/or
i) the composition comprises additional acid and/or base.

5-10. (canceled)

11. The composition of claim 1, wherein:
a) the concentration of the phthalimide fungicide is between 5% to 90% by weight or between 10% to 85% by weight based on the total weight of the composition,
b) the phthalimide fungicide is up to 80% or up to 70% by weight based on the total weight of the composition, and/or
c) the phthalimide fungicide is at least 35% by weight based on the total weight of the composition.

12-15. (canceled)

16. The composition of claim 1, wherein the concentration of the phthalimide fungicide is about 50% by weight based on the total weight of the composition.

17. The composition of claim 1, wherein the concentration of the phthalimide fungicide in the composition is between 10 and 800 g/L or between 100 and 500 g/L.

18-23. (canceled)

24. The composition of claim 1, wherein the weight ratio between the phthalimide fungicide and the acetic acid-based buffer is 30:1 to 10:1.

25. The composition of claim 1, wherein the composition comprises an amount of the acetic acid-based buffer that provides a pH level of 4 to 7 before storage.

26. The composition of claim 1, wherein:
a) the acetic acid-based buffer is obtained from mixing acetic acid and acetate salt,
b) the acetic acid-based buffer is obtained from mixing acetic acid and base different from acetate salt,
c) the acetic acid-based buffer is obtained from mixing acetate salt with acid different from acetic acid, or
d) the acetic acid-based buffer is obtained by mixing inorganic acid and/or stronger acid than acetic acid with acetic acid conjugate base (acetate), or
e) the acetic acid-based buffer is obtained by using a base selected from inorganic base, organic base and combination thereof.

27-31. (canceled)

32. The composition of claim 1, wherein the composition further comprises an amount of polyelectrolyte complex.

33. The composition of claim 32, wherein;
a) the polyelectrolyte complex is a complex of a polycation and a polyanion, and/or
b) the amount of polyelectrolyte in the composition is 0.01-10% w/w.

34. The composition of claim 33, wherein the polycation is chitosan, and/or the polyanion is PAA and/or sodium lignosulfonate.

35-37. (canceled)

38. A method of stabilizing a composition comprising a phthalimide fungicide comprising maintaining the pH of the composition comprising the phthalimide fungicide above 4 during storage using an acetic acid-based buffer.

39. A method for stabilizing composition comprising phthalimide fungicide, the method comprises formulating the phthalimide in the presence of acetic acid-based buffer.

40. A process for preparing the composition of claim 1, wherein the process comprises suspending the phthalimide fungicide in water comprising at least one surfactant, wherein the acetic acid-based buffer is added to the water prior to addition of the phthalimide or after addition of the phthalimide fungicide.

41. The process of claim 40, wherein when the composition further comprises polyelectrolyte complex, the process comprises (a) preparing an aqueous composition of a polyelectrolyte complex, (b) adding at least one surfactant to the aqueous composition, and (c) mixing a phthalimide fungicide into the aqueous composition.

42. A method of treating a plant, or a part of a plant, against a pathogen, comprising contacting the plant, or part of the plant, with the composition of claim 1.

43. The method of claim 42, wherein:
a. the method protects the plant, or a part of a plant, against the pathogen and comprises contacting the plant, or part of the plant with the composition of claim 1,
b. the method prevents, reduces and/or eliminates the presence of the pathogen on the plant, or part of the plant, and comprises contacting the plant, or part of the plant, with the composition of claim 1, or
c. the method controls diseases caused by phytopathogenic fungi in plants or on propagation material thereof, and comprises contacting the plants, the locus thereof or propagation material thereof, with the composition of claim 1.

44. A method of controlling or preventing pest comprising contacting (i) the pest or a locus thereof, (ii) a plant or a locus or propagation material thereof, (iii) soil, and/or (iv) an area in which pest infestation is to be controlled or prevented with the composition of claim 1.

45-47. (canceled)
